(19) United States
(12) Patent Application Publication
(10) Pub. No.: US 2022/0129507 A1
(43) Pub. Date: Apr. 28, 2022

(54) System and Method for Personalized Query and Interaction Set Generation using Natural Language Processing Techniques for Conversational Systems

(71) Applicant: Aviso INC., Redwood City, CA (US)

(72) Inventors: Joy MUSTAFI, Hyderabad (IN); Sayan Deb KUNDU, Kolkata (IN); Gopikrishna NUTI, Bachupally (IN); Sudip DAS, Kolkata (IN); Trevor RODRIGUES, Scottsdale, AZ (US)

(73) Assignee: Aviso LTD., Redwood City, CA (US)

(21) Appl. No.: 17/082,842

(22) Filed: Oct. 28, 2020

(51) Int. Cl. G06F 16/9032; G06F 16/9535; G06N 20/00; G10L 15/19; G10L 15/22; G10L 13/02; G10L 15/30; G10L 15/18

(52) U.S. Cl. CPC G06F 16/90332; G06F 16/9535; G06N 20/00; G10L 15/1815; G10L 15/22; G10L 13/02; G10L 15/30; G10L 15/19

(57) ABSTRACT

A conversational system and a method for personalized query and interaction set generation. The conversational system includes a system server, a business database server, a user device. The system server further includes a system processing unit. The data points are extracted by a system processing unit from a business database server. The system processing unit creates improved multiple datasets that include the grammatically correct query, corresponding responses of the grammatically correct query, and corresponding data points related to the grammatically correct query. The multiple datasets are being fed into the conversational module to train the conversational module. The user sends queries to the system server through the user device. The system processing unit sends a query to the conversational module. The conversation module sends the query to a search engine that searches data and sends data to an answer generating module to send the answer to the user.

### FIELD OF INVENTION

The present invention relates to a voice assistant system and more specifically relates to a method for personalized query and interaction set generation using natural language processing techniques for a conversational system.

Today's electronic devices are able to access a large number of functions, services, and information, both via the Internet and from other sources. The functionality for such devices is increasing rapidly, as these devices are able to run software applications to perform various tasks and provide different types of information.

In order to access information from the Internet and other sources, the user needs to manually feed queries into their devices to search for information. A feeding query is a very tiring process. Further, most of the devices just search based on the keywords but not based on the whole grammatically structured query that is being fed into the device. Also, they display multiple information and the user has to go through all the results that he is searching for.

In order to ease the access information, the device is provided with a voice assistant. Not only Voice Assistant is utmost helpful for a blind person since they are not able to browse his needs from the internet by itself, parallel it helps to retrieve the required pieces of information without digging on the website for the other people.

Although the existing voice assistant system already has acquired promising performance on the moderately well-behaved scenarios. However, the existing voice Assistant is for the general assistant. The existing voice Assistant does not help the user to retrieve the required deals information from the real-time hierarchical business database of an organization.

Patent application U.S. Pat. No. 9,318,108B2 discloses an intelligent automated assistant system engages with the user in an integrated, conversational manner using natural language dialog, and invokes external services when appropriate to obtain information or perform various actions. The system can be implemented using any of a number of different platforms, such as the web, email, smartphone, and the like, or any combination thereof. In one embodiment, the system is based on sets of interrelated domains and tasks and employs additional functionally powered by external services with which the system can interact.

The existing invention does not provide a freewheeling conversation. The existing invention is unable to generate a correct query for an assistant. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a method for personalized query and interaction set generation using natural language processing techniques for a conversational system. The method includes:

A method of generating the query, the method having: data points are extracted by a system processing unit from a business database server, and the data points are categorized in a heuristic manner. The system processing unit executes computer-readable instruction to create a grammatical database of determiners, quantifiers, prepositions, and applicable parts of speech for each category of data points, and the grammatical database is connected to a system server. The system processing unit of the system server fetches determiners, quantifiers, prepositions, and a list of parts of speech that are being used by a query generator module to generate all possible queries related to each category of the data points. Herein, the query generator module is stored in a system server memory. Further, the system processing unit executes a grammar compatibility checker module that checks the grammar of the all generated query, wherein, the grammar compatibility checker module is stored in the system server memory. In case, the generated query is grammatically incorrect, the generated query gets discarded, In case, the generated query is grammatically correct, the system processing unit creates multiple datasets that include the grammatically correct query, corresponding responses of the grammatically correct query, and corresponding data points related to the grammatically correct query. Further, the datasets are stored in the intermediate question database that is connected to the system server. The system processing unit further improved multiple datasets that include a more personalized grammatically correct query, corresponding personalized responses of the grammatically correct query, and corresponding data points related to the grammatically correct query. Further, the improved multiple datasets are stored in the final question database that is connected to the system server.

A method of training a conversational module, the method having: A multiple datasets of a personalized grammatically correct query, corresponding personalized responses of grammatically correct query and corresponding data points related to the grammatically correct query are being fed into the conversational module by the system processing unit. The conversational module learns from the datasets about the various type query based on a particular category of question and learns about the intent associated with each query. Further, the conversational module is tested and optimized. The conversational module is stored in a question and response database that is connected to the system server.

Herein, the data points in multiple datasets of the final question database help the conversational module to clarify the intent that is associated with the personalized grammatically correct query and corresponding personalized responses of the grammatically correct query.

A method for a freewheeling conversational assistant, the method having: A user sends voice query to the system server through a user device. The system processing unit of the system server executes computer-readable instruction to convert voice to text using a speech to text module. The system processing unit executes computer-readable instruction to extract intent data points from the text by using an intention recognition module. The system processing unit sends the intent data point along with the query in text format to the conversational module. The conversation module understands the intent of query using intent data point and previous learning from the multiple datasets of the final question database. The conversation module sends the well-structured query to a search engine that searches data as per the intent of the query and sends the required data to an answer generating module. The answer generating module generates a well-structured and graphical answer and sends the answer to the user device.

Herein, the query generator module, the grammar compatibility checker module, the text to speech module, intention recognition module, and the answer generating module are stored in the system server memory.

The main advantage of the present invention is that the present invention provides a freewheeling conversation with the assistant.

Yet another advantage of the present invention is that the present invention is trained with multiple queries, thus unable to understand query effectively.

Yet another advantage of the present invention is that the present invention easily understand the intent of the query

Yet another advantage of the present invention is that the present invention provides an answer to the query in a grammatically well-structured sentence along with graphics.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates an architecture diagram of method of the present invention.

FIG. 2 illustrates a method flow chart of generating the query.

FIG. 3 illustrates a block diagram of the present invention.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

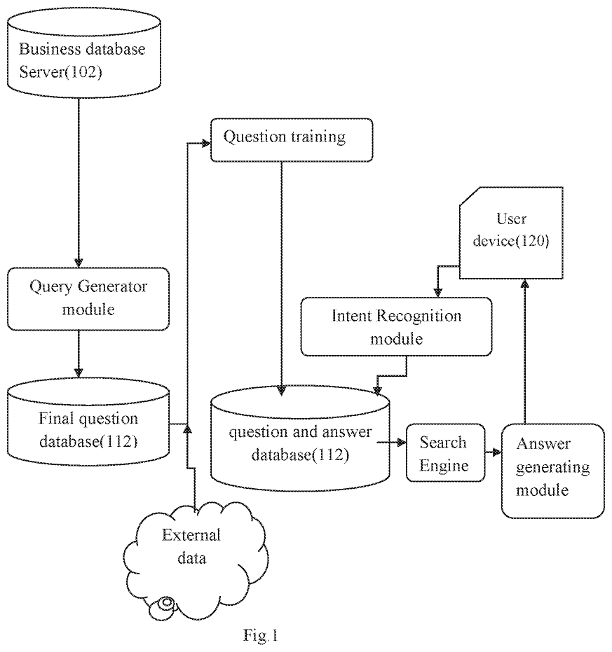

FIG. 1 illustrates an architectural block diagram of the method of a conversational system (100). The data points are extracted from a business database server (102), and the data points are categorized in a heuristic manner. A query generator module generates all possible queries related to each category of the data points. Further improved multiple datasets that include a more personalized grammatically correct query, corresponding personalized responses of the grammatically correct query, and corresponding data points related to the grammatically correct query, are stored in the final question database (112). The data points are also extracted from external database and the Internet. A multiple datasets of a personalized grammatically correct query, corresponding personalized responses of grammatically correct query and corresponding data points related to the grammatically correct query are being fed into the conversational module. The conversational module learns from the datasets about the various type query based on a particular category of question and learns about the intent associated with each query. The conversational module is stored in a question and response database (118) that is connected to the system server (104). A user sends a voice query to the system server (104) through a user device (116). The voice query is converted voice to text. The intent data point from text is extracted by using an intention recognition module. The intent data point along with the query in text format is sent to the conversational module. The conversation module understands the intent of the query using the intent data point. The conversation module sends the well-structured query to a search engine that searches data as per the intent of the query and sends the required data to an answer generating module. The answer generating module generates a well-structured and graphical answer and sends the answer to the user device (116).

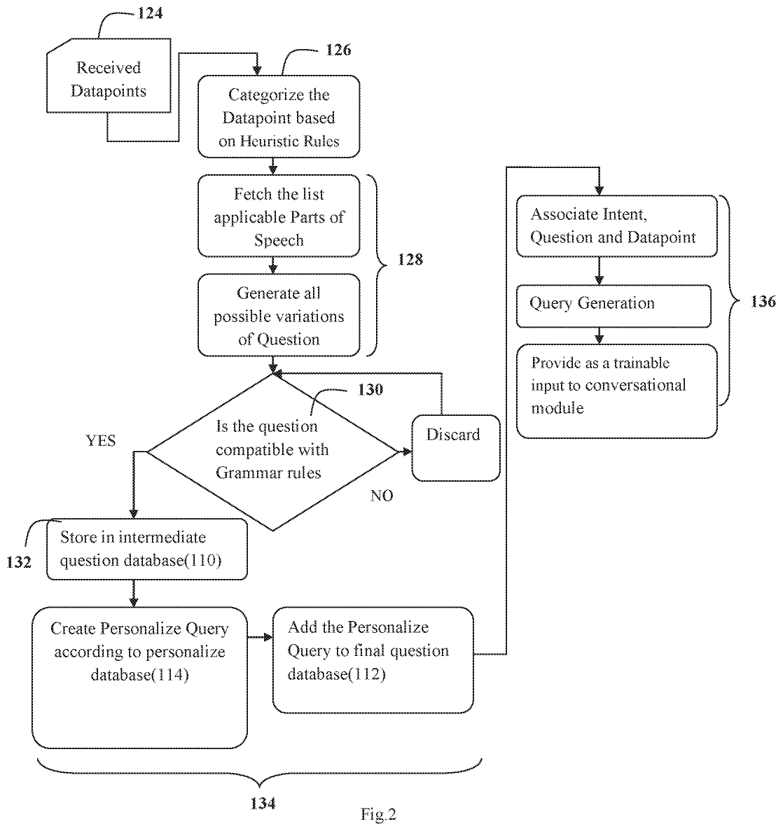

FIG. 2 illustrates a method flow chart of generating the query. In Step (124), the data points are extracted by a system processing unit (106) from a business database server (102). In Step (126), the data points are categorized in a heuristic manner. In step (128), the system processing unit (106) of the system server (104) fetches determiners, quantifiers, prepositions, and a list of parts of speech that are being used by a query generator module to generate all possible query related to each category of the data points. In Step (130), the system processing unit (106) executes a grammar compatibility checker module that checks grammar of the all generated query. In case, the generated query is grammatically incorrect, the generated query gets discarded, In case, the generated query is grammatically correct, Step (132) follows and the system processing unit (106) creates multiple datasets that include the grammatically correct query, corresponding responses of the grammatically correct query, and corresponding data points related to the grammatically correct query, further, the datasets are stored in the intermediate question database (110). In Step (134), the system processing unit (106) further improved multiple datasets that include a more personalized grammatically correct query, corresponding personalized responses of the grammatically correct query, and corresponding data points related to the grammatically correct query, further the improved multiple datasets are stored in the final question database (112) Herein, the system processing unit (106) extracts data from a personalized database (114) and mapped the data with datasets of the intermediate question database (110) further create the final question database (112) having more personalized grammatically correct query, corresponding personalized responses of the grammatically correct query, and corresponding data points related to the grammatically correct query. In Step (136), multiple datasets of a personalized grammatically correct query, corresponding personalized responses of grammatically correct query and corresponding data points related to the grammatically correct query are being fed into the conversational module by the system processing unit (106) for training.

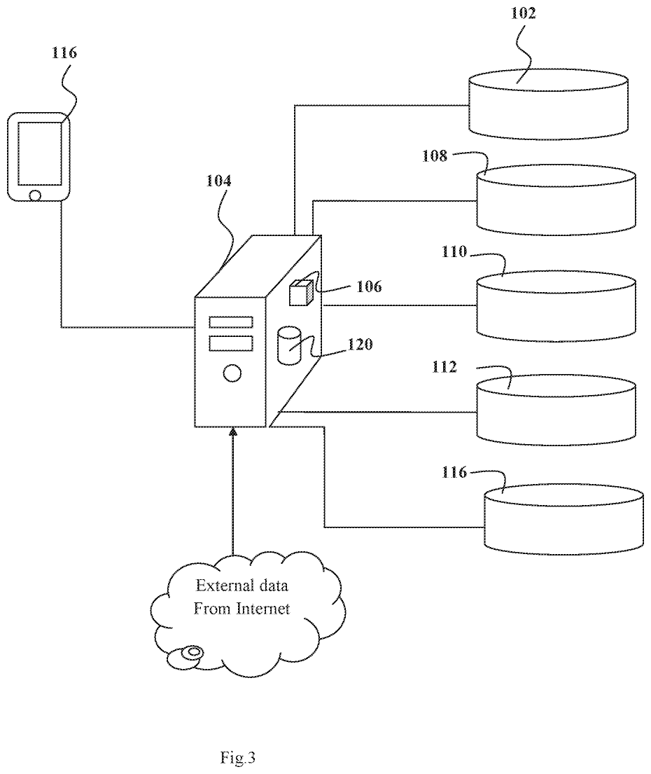

FIG. 3 illustrates a block diagram of a conversational system (100). The conversational system (100) includes a system server (104), a business database server (102), a grammatical database (108), an intermediate question database (110), a final question database (112), a question and response database (118), and a user device (116). The system server (104) further includes a system processing unit (106), a system server memory (120). The system server memory (120) stores the query generator module, the grammar compatibility checker module, the text to speech module, intention recognition module, and the answer generating module. The business database server (102) is connected to the system server (104). The grammatical database (108) is connected to the system server (104). The grammatical database (108) stores determiners, quantifiers, prepositions, and applicable parts of speech. The intermediate question database (110) is connected to the system server (104). The final question database (112) is connected to the system server (104). The question and response database (118) is connected to the system server (104). The conversational module is stored in the question and response database (118). The user device (116) is connected to the system server (104). In the preferred embodiment, the at least one system processing unit (106) from the business database server (102) and also extracts data points from external databases and the internet.

The present invention relates to a method for personalized query and interaction set generation using natural language processing techniques for a conversational system. The method includes:

A method of generating the query, the method having

data points are extracted by a system processing unit from a business database server, and the data points are categorized in a heuristic manner;

the system processing unit executes computer-readable instruction to create a grammatical database of determiners, quantifiers, prepositions, and applicable parts of speech for each category of a data point, and the grammatical database is connected to a system server;

the system processing unit of the system server fetches determiners, quantifiers, prepositions, and a list of parts of speech that are being used by a query generator module to generate all possible query related to each category of the data points, wherein, the query generator module is stored in a system server memory;

further, the system processing unit executes a grammar compatibility checker module that checks grammar of the all generated query, herein, the grammar compatibility checker module is stored in the system server memory;

In case, the generated query is grammatically incorrect, the generated query gets discarded,

In case, the generated query is grammatically correct, the system processing unit creates multiple datasets that include the grammatically correct query, corresponding responses of the grammatically correct query, and corresponding data points related to the grammatically correct query, further, the datasets are stored in the intermediate question database that is connected to the system server; and

the system processing unit further improved multiple datasets that include a more personalized grammatically correct query, corresponding personalized responses of the grammatically correct query, and corresponding data points related to the grammatically correct query, further the improved multiple datasets are stored in the final question database that is connected to the system server;

Herein, the system processing unit extracts data from a personalized database and mapped the data with datasets of the intermediate question database further create the final question database having more personalized grammatically correct query, corresponding personalized responses of the grammatically correct query, and corresponding data points related to the grammatically correct query.

In the preferred embodiment, data points are extracted by the system processing unit from the business database server and also extract data points from an external database and the internet.

In the preferred embodiment, the business database server includes, but not limited to, a company CRM server, an ERP Server, accompany email and a web server, and any combination thereof.

In the preferred embodiment, the query generator module, and grammar compatibility checker module are trained Natural Language Processing Module.

A method of training a conversational module, the method having

a multiple datasets of a personalized grammatically correct query, corresponding personalized responses of grammatically correct query and corresponding data points related to the grammatically correct query are being fed into the conversational module by the system processing unit;

the conversational module learns from the datasets about the various type query based on a particular category of question and learns about the intent associated with each query;

further, the conversational module is tested and optimized; and

the conversational module is stored in a question and response database that is connected to the system server.

Herein, the data points in multiple datasets of the final question database help the conversational module to clarify the intent that is associated with the personalized grammatically correct query and corresponding personalized responses of the grammatically correct query.

In the preferred embodiment, the conversational module is a Natural Language Processing Module that is further being trained by multiple datasets of the personalized grammatically correct query, corresponding personalized responses of the grammatically correct query, and corresponding data points related to the grammatically correct query.

A method for a freewheeling conversational assistant, the method having

a user send voice query to the system server through a user device;

the system processing unit of the system server executes computer-readable instruction to convert voice to text using a speech to text module;

the system processing unit executes computer-readable instruction to extract intent data point from the text by using an intention recognition module;

the system processing unit sends the intent data point along query in text format to the conversational module;

the conversation module understand the intent of query using intent data point and previous learning from the multiple datasets of final question database;

the conversation module sends the well-structured query to a search engine that searches data as per the intent of the query and sends required data to an answer generating module; and

the answer generating module generates a well-structured and graphical answer and sends the answer to the user device.

Herein, the query generator module, the grammar compatibility checker module, the text to speech module, intention recognition module, and the answer generating module are stored in the system server memory.

In the preferred embodiment, the speech to the text module, the intention recognition module, and the answer generating module are trained Natural Language Processing Module.

In the preferred embodiment, the conversational module provides smooth and freewheeling conversation between the system server and human user with the help of the user device.

In an embodiment, the user device is selected from a desktop computer, a laptop, a tablet, a smartphone, a mobile phone.

In an embodiment, the present invention relates to a method for personalized query and interaction set generation using natural language processing techniques for a conversational system. The method includes:

A method of generating the query, the method having

data points are extracted by one or more system processing units from one or more business database servers, and the data points are categorized in a heuristic manner;

the one or more system processing units execute computer-readable instruction to create a grammatical database of determiners, quantifiers, prepositions, and applicable parts of speech for each category of a data point, and the grammatical database is connected to a system server;

the one or more system processing units of the system server fetches determiners, quantifiers, prepositions, and a list of parts of speech that are being used by a query generator module to generate all possible query related to each category of the data points, wherein, the query generator module is stored in a system server memory;

further, the one or more system processing units execute a grammar compatibility checker module that checks grammar of the all generated query, wherein, the grammar compatibility checker module is stored in the system server memory;

In case, the generated query is grammatically incorrect, the generated query gets discarded,

In case, the generated query is grammatically correct, the one or more system processing units create multiple datasets that include the grammatically correct query, corresponding responses of the grammatically correct query, and corresponding data points related to the grammatically correct query, further, the datasets are stored in the intermediate question database that is connected to the system server; and

the one or more system processing units further improved multiple datasets that include a more personalized grammatically correct query, corresponding personalized responses of the grammatically correct query, and corresponding data points related to the grammatically correct query, further the improved multiple datasets are stored in the final question database that is connected to the system server.

Herein, the one or more system processing units extract data from a personalized database and mapped the data with datasets of the intermediate question database further create the final question database having more personalized grammatically correct query, corresponding personalized responses of the grammatically correct query, and corresponding data points related to the grammatically correct query.

In the preferred embodiment, data points are extracted by the one or more system processing units from the one or more business database servers and also extract data points from an external database that are present on the internet.

In the preferred embodiment, the one or more business database servers include, but not limited to, a company CRM server, an ERP Server, accompany email and a web server and any combination thereof.

In the preferred embodiment, the query generator module, and grammar compatibility checker module are trained Natural Language Processing Module.

A method of training a conversational module, the method having

a multiple datasets of a personalized grammatically correct query, corresponding personalized responses of grammatically correct query and corresponding data points related to the grammatically correct query are being fed into the conversational module by the one or more system processing units;

the conversational module learns from the datasets about the various type query based on a particular category of question and learns about the intent associated with each query;

further, the conversational module is tested and optimized; and

the conversational module is stored in a question and response database that is connected to the system server.

Herein, the data points in multiple datasets of the final question database help the conversational module to clarify the intent that is associated with the personalized grammatically correct query and corresponding personalized responses of the grammatically correct query.

In the preferred embodiment, the conversational module is the Natural Language Processing Module that is further being trained by multiple datasets of the personalized grammatically correct query, corresponding personalized responses of the grammatically correct query, and corresponding data points related to the grammatically correct query.

A method for a freewheeling conversational assistant, the method having

a user send voice query to the system server through one or more user devices;

the one or more system processing units of the system server execute computer-readable instruction to convert voice to text using a speech to text module;

the one or more system processing units execute computer-readable instruction to extract intent data point from the text by using an intention recognition module;

the one or more system processing units send the intent data point along with query in text format to the conversational module;

the conversation module understand the intent of query using intent data point and previous learning from the multiple datasets of final question database;

the conversation module sends the well-structured query to a search engine that searches data as per the intent of the query and sends required data to an answer generating module; and

the answer generating module generates a well-structured and graphical answer and sends the answer to the one or more user devices.

Herein, the query generator module, the grammar compatibility checker module, the text to speech module, intention recognition module, and the answer generating module are stored in the system server memory.

In the preferred embodiment, the speech to text module, the intention recognition module and the answer generating module are trained Natural Language Processing Module.

In the preferred embodiment, the conversational module provides smooth and freewheeling conversation between the system server and human user with the help of the one or more user devices.

In an embodiment, the one or more user devices are selected from a desktop computer, a laptop, a tablet, a smartphone, a mobile phone.

In an embodiment, the method for personalized query and interaction set generation using natural language processing techniques are being executed with the help of a conversational system. The conversational system includes a system server, a business database server, a grammatical database, an intermediate question database, a final question database, a question and response database, a user device. The system server further includes a system processing unit, a system server memory. The system processing unit executes computer-readable instructions for personalized query and interaction set generation using natural language processing techniques. Thus helps in the smooth and freewheeling conversation between the system server and a human user through the user device. The system server memory stores the query generator module, the grammar compatibility checker module, the text to speech module, intention recognition module, and the answer generating module. The business database server is connected to the system server. The system processing unit extracts data points for personalized query and interaction set generation. The grammatical database is connected to the system server. The grammatical database stores determiners, quantifiers, prepositions, and applicable parts of speech that are being used by a query generator module to generate all possible queries. The intermediate question database is connected to the system server. The multiple datasets that include the grammatically correct query, corresponding responses of the grammatically correct query, and corresponding data points related to the grammatically correct query, are stored in the intermediate question database. The final question database is connected to the system server. The multiple datasets that include a more personalized grammatically correct query, corresponding personalized responses of the grammatically correct query, and corresponding data points related to the grammatically correct query, are stored in the final question database. The question and response database is connected to the system server. The conversational module is stored in the question and response database. The user device is connected to the system server. A user sends voice query to the system server through the user device. Herein, the system processing unit extracts data from a personalized database and mapped the data with datasets of the intermediate question database further create the final question database having more personalized grammatically correct query, corresponding personalized responses of the grammatically correct query, and corresponding data points related to the grammatically correct query. In the preferred embodiment, the system processing unit from the business database server and also extracts data points from external databases and the internet.

In another embodiment, the method for personalized query and interaction set generation using natural language processing techniques are being executed with the help of a conversational system. The conversational system includes a system server, one or more business database servers, a grammatical database, an intermediate question database, a final question database, a question and response database, and one or more user devices. The system server further includes one or more system processing units, a system server memory. The one or more system processing units execute computer-readable instructions for personalized query and interaction set generation using natural language processing techniques. Thus helps in a smooth and freewheeling conversation between the system server and a human user through the one or more user devices. The system server memory stores the query generator module, the grammar compatibility checker module, the text to speech module, intention recognition module, and the answer generating module. The one or more business database servers are connected to the system server. The one or more system processing units extract data points for personalized query and interaction set generation. The grammatical database is connected to the system server. The grammatical database stores determiners, quantifiers, prepositions, and applicable parts of speech that are being used by a query generator module to generate all possible queries. The intermediate question database is connected to the system server. The multiple datasets that include the grammatically correct query, corresponding responses of the grammatically correct query, and corresponding data points related to the grammatically correct query, are stored in the intermediate question database. The final question database is connected to the system server. The multiple datasets that include a more personalized grammatically correct query, corresponding personalized responses of the grammatically correct query, and corresponding data points related to the grammatically correct query, are stored in the final question database. The question and response database is connected to the system server. The conversational module is stored in the question and response database. The one or more user devices are connected to the system server. A user sends a voice query to the system server through one or more user devices. Herein, the one or more system processing units extract data from a personalized database and mapped the data with datasets of the intermediate question database further create the final question database having more personalized grammatically correct query, corresponding personalized responses of the grammatically correct query, and corresponding data points related to the grammatically correct query. In the preferred embodiment, the one or more system processing units from the one or more business database servers and also extract data points from external databases and the internet.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A method for personalized query and interaction set generation using natural language processing techniques for a conversational system, the method comprising:
a method of generating the query, the method having
data points are extracted by an at least one system processing unit from an at least one business database server, and the data points are categorized in a heuristic manner,
the at least one system processing unit executes computer-readable instruction to create a grammatical database of determiners, quantifiers, prepositions, and applicable parts of speech for each category of data points, and the grammatical database is connected to a system server,
the at least one system processing unit of the system server fetches determiners, quantifiers, prepositions, and a list of parts of speech that are being used by a query generator module to generate all possible query related to each category of the data points, wherein, the query generator module is stored in an at least one system server memory,
further, at least one system processing unit executes a grammar compatibility checker module that checks grammar of the all generated query, wherein, the grammar compatibility checker module is stored in the at least one system server memory,
in case, the generated query is grammatically incorrect, the generated query gets discarded,
in case, the generated query is grammatically correct, the at least one system processing unit creates multiple datasets that include the grammatically correct query, corresponding responses of the grammatically correct query, and corresponding data points related to the grammatically correct query, further, the datasets are stored in the intermediate question database that is connected to the system server, and
the at least one system processing unit further improved multiple datasets that include a more personalized grammatically correct query, corresponding personalized responses of the grammatically correct query, and corresponding data points related to the grammatically correct query, further, the improved multiple datasets are stored in the final question database that is connected to the system server;
wherein, the at least one system processing unit extracts data from a personalized database and mapped the data with datasets of the intermediate question database further create the final question database having more personalized grammatically correct query, corresponding personalized responses of the grammatically correct query, and corresponding data points related to the grammatically correct query;
a method of training a conversational module, the method having
a multiple datasets of a personalized grammatically correct query, corresponding personalized responses of grammatically correct query and corresponding data points related to the grammatically correct query are being fed into the conversational module by the at least one system processing unit,
the conversational module learns from the datasets about the various type query based on a particular category of question and learns about the intent associated with each query,
further, the conversational module is tested and optimized, and
the conversational module is stored in a question and response database that is connected to the system server,
wherein, the data points in multiple datasets of the final question database help the conversational module to clarify the intent that is associated with the personalized grammatically correct query and corresponding personalized responses of the grammatically correct query; and
a method for a freewheeling conversational assistant, the method having
a user send voice query to the system server through an at least one user device,
the at least one system processing unit of the system server executes computer-readable instruction to convert voice to text using a speech to the text module,
the at least one system processing unit executes computer-readable instruction to extract intent data point from a text by using an intention recognition module,
the at least one system processing unit sends the intent data point along with query in text format to the conversational module,
the conversation module understand the intent of query using intent data point and previous learning from the multiple datasets of final question database,
the conversation module sends the well-structured query to a search engine that searches data as per the intent of the query and sends required data to an answer generating module, and
the answer generating module generates a well structured and graphical answer and send the answer to the at least one user device;
wherein, the query generator module, the grammar compatibility checker module, the text to speech module, intention recognition module, and the answer generating module are stored in the at least one system server memory.

2. The method as claimed in claim 1, wherein, data points are extracted by the at least one system processing unit from the at least one business database server and also extracts data points from an external database and the internee.

3. The at least one business database server as claimed in claim 1, wherein the at least one business database server is selected from a company CRM server, an ERP Server, accompany email and a web server and any combination thereof.

4. The method as claimed in claim 1, wherein, the query generator module, and grammar compatibility checker module is trained Natural Language Processing Module.

5. The conversational module as claimed in claim 1, wherein, the conversational module is Natural Language Processing Module that is further being trained by multiple datasets of the personalized grammatically correct query, corresponding personalized responses of grammatically correct query and corresponding data points related to the grammatically correct query.

6. The method as claimed in claim 1, wherein, the speech to text module, the intention recognition module and the answer generating module are trained Natural Language Processing Module.

7. The conversational module as claimed in claim 1, wherein, the conversational module provides smooth and freewheeling conversation between the system server and a human user with the help of at least one user device.

8. The at least one user device as claimed in claim 1, at least one user device is selected from a desktop computer, a laptop, a tablet, a smartphone, a mobile phone.

9. The method as claimed in claim 1, wherein the method for personalized query and interaction set generation using natural language processing techniques are being executed with the help of a conversational system, the conversational system comprising:
the system server, the system server having
the at least one system processing unit, the at least one system processing unit executes computer-readable instructions for personalized query and interaction set generation using natural language processing techniques and thus helps in a smooth and freewheeling conversation between the system server and a human user through the at least one user device,
the system server memory, the system server memory stores the query generator module, the grammar compatibility checker module, the text to speech module, intention recognition module and the answer generating module;
the at least one business database server, the at least one business database server is connected to the system server, the at least one system processing unit extract data point for personalized query and interaction set generation;
the grammatical database, the grammatical database is connected to the system server, the grammatical database stores determiners, quantifiers, prepositions, and applicable parts of speech that are being used by a query generator module to generate all possible query;
the intermediate question database, the intermediate question database is connected to the system server, the multiple datasets that include the grammatically correct query, corresponding responses of the grammatically correct query, and corresponding data points related to the grammatically correct query, are stored in the intermediate question database;
the final question database, the final question database is connected to the system server, the multiple datasets that include a more personalized grammatically correct query, corresponding personalized responses of grammatically correct query and corresponding data points related to the grammatically correct query, are stored in the final question database; and
the question and response database, the question and response database is connected to the system server, the conversational module is stored in the question and response database; and
the at least one user device, the at least one user device is connected to the system server, a user sends voice query to the system server through an at least one user device;
wherein, the at least one system processing unit extracts data from a personalized database and mapped the data with datasets of the intermediate question database further create the final question database having more personalized grammatically correct query, corresponding personalized responses of the grammatically correct query, and corresponding data points related to the grammatically correct query.
